(19) United States
(12) Patent Application Publication
(10) Pub. No.: US 2016/0034423 A1
(43) Pub. Date: Feb. 4, 2016

(54) Algorithm for Optimization and Sampling

(71) Applicant: Microsoft Corporation, Redmond, WA (US)

(72) Inventors: Matthew B. Hastings, Santa Barbara, CA (US); Matthias Troyer, Zurich (CH); Ilia Zintchenko, Zurich (CH)

(21) Appl. No.: 14/450,655

(22) Filed: Aug. 4, 2014

(51) Int. Cl. G06F 17/18; G06F 17/50

(52) U.S. Cl. CPC G06F 17/18; G06F 17/5009

(57) ABSTRACT

In some examples, techniques and architectures for solving combinatorial optimization or statistical sampling problems use a hierarchical approach. Such a hierarchical approach may be applied to a system or process in a patch-like fashion. A set of elements of the system correspond to a first tier. An objective function associates the set of elements with one another. The set of elements are partitioned into patches corresponding to a second tier. The patches individually include second tier elements that are subsets of the set of elements, and the individual patches have an energy configuration. The second tier elements of the patches are randomly initialized. Based, at least in part, on the objective function, a combinatorial optimization operation is performed on the second tier elements of the individual patches to modify the second tier elements of the individual patches.

### BACKGROUND

Existing approaches to optimization depend on the type of systems or processes involved, including engineering system design, optical system design, economics, power systems, circuit board design, transportation systems, scheduling systems, resource allocation, personnel planning, structural design, and control systems. Goals of optimization procedures typically include obtaining the “best” or “near-best” results possible, in some defined sense, subject to imposed restrictions or constraints. Thus, optimizing a system or a process generally involves developing a model of the system or process and analyzing performance changes that result from adjustments in the model.

Depending on the application, complexity of such a model ranges from very simple to extremely complex. An example of a simple model is one that can be represented by a single algebraic function of one variable. On the other hand, complex models often contain thousands of linear and nonlinear functions of many variables.

Sometimes optimization problems are described as energy minimization problems, in analogy to a physical system having an energy represented by a function called an energy function or an objective function. Often a feasible solution that minimizes (or maximizes, if that is the goal) an objective function is called an optimal solution. In a minimization problem, there may be several local minima and local maxima. Most algorithms for solving optimization problems are not capable of making a distinction between local optimal solutions (e.g., finding local extrema) and rigorous optimal solutions (e.g., finding the global extrema). Moreover, many algorithms take an exponentially large amount of time for optimization problems due to the phenomenon of trapping in local minima.

### SUMMARY

This disclosure describes techniques and architectures for solving combinatorial optimization or statistical sampling problems using a recursive hierarchical approach. Such an approach is applied to a system or process in a patch-like fashion. A system or process may be defined by a set of elements distributed in an n-dimensional space according to values of the individual elements. For example, such elements may include sampled or collected data. The entire set of elements may correspond to a first tier of a hierarchy. An objective function associates the set of elements with one another. In individual steps of the recursive process of solving an optimization problem, for example, the set of elements may be partitioned into patches corresponding to higher-order tiers of the hierarchy, such as a second tier, a third tier, and so on. A patch is a subset of the set of elements and has a particular energy configuration. Elements of individual patches are randomly initialized. Based on the objective function, a combinatorial optimization operation or a statistical sampling operation is performed on the individual patches to modify elements of the individual patches. The combinatorial optimization operation or the statistical sampling operation may be a simulated annealing operation, for example.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), quantum devices, such as quantum computers or quantum annealers, and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIG. 1 is a block diagram depicting an environment for solving combinatorial optimization or statistical sampling problems using a hierarchical approach, according to various examples.

FIG. 2 is a block diagram depicting a device for solving combinatorial optimization or statistical sampling problems using a hierarchical approach, according to various examples.

FIG. 3 illustrates a cross-sectional view of sets of patches on a number of tiers in relation to an objective function, according to various examples.

FIG. 4 illustrates a perspective view of sets of patches on a number of tiers in relation to an objective function, according to various examples.

FIG. 5 illustrates two patches defined within particular distances from a patch-center, according to some examples.

FIGS. 6 and 7 are flow diagrams illustrating processes for solving optimization problems, according to some examples.

### DETAILED DESCRIPTION

### Overview

In many applications, a system or process to be optimized may be formulated as a mathematical model that is analyzed while solving an optimization problem. For example, such an optimization problem involves maximizing or minimizing a real function by systematically choosing input values from within an allowed set and computing the value of the function. Thus, an initial step in optimization may be to obtain a mathematical description of the process or the system to be optimized. A mathematical model of the process or system is then formed based, at least in part, on this description.

In various examples, a computer system is configured with techniques and architectures as described herein for solving a combinatorial optimization or statistical sampling problem. Such a problem, for example, may be defined by an energy function and described as a minimization problem for finding the minimum energy of the energy function. The energy function associates a set of elements that further define the combinatorial optimization or statistical sampling problem with one another by.

Though techniques and architectures described herein are applicable to combinatorial optimization problems and statistical sampling problems, the discussion focuses on combinatorial optimization problems, hereinafter “optimization problems”, for sake of clarity. The claimed subject matter is not so limited.

A processor of a computer system uses a recursive hierarchical process for solving optimization problems by partitioning the set of elements into patches on multiple tiers of a hierarchy. For example, a first tier may comprise the entire set of elements, which the processor may partition into several second tier patches, each being a subset of the set of elements of the first tier. The processor may partition each of the second tier patches into third tier patches and each of the third tier patches into fourth tier patches, and so on.

Recursive steps of the process include initializing each of the multiple tiers of patches by setting individual elements of the patches to a random value. In some implementations, however, such initialization need not be random, and claimed subject matter is not limited in this respect. Based on the energy function, a processor may perform an optimization operation on the patches to modify the elements of the patches to generate modified patches. In some implementations, such a processor may be a quantum device, such as a quantum computer or quantum annealer. As described herein, performing the optimization operation on patches involves executing (e.g., “calling”) a function “SOLVE”, which comprises one or more operations that operate on the patches. In some examples, SOLVE comprises executable instructions on computer-readable media that, when executed by one or more processors, configure the one or more processors to perform the one or more operations that operate on the patches. For instance, the combinatorial optimization operation may be a simulated annealing operation.

After performing the optimization operation, the processor may compare the resulting energy of each modified patch to the energy of the patch before the optimization operation. If the optimization operation yielded a lower energy, then the processor retains and uses the elements of the modified patch for a subsequent application of the optimization operation. On the other hand, if the optimization operation yielded an energy higher than the previous energy, then the processor either discards or retains the elements of the modified patch based on a probability function and uses the elements of the modified patch for a subsequent application of the optimization operation. Such a probability function, as discussed in detail below, may depend on a number of parameters, such as the tier in which the patch resides, the number of optimization operations performed, and so on.

After performing a number of optimization operations that yield modified patches having sufficiently low energies, the process may repeat in a “restart” process. For example, such a restart process may involve randomly re-initializing individual elements of the modified patches. The restart process repeats the optimization operations on the modified patches having the re-initialized elements. Subsequent restart processes tend to yield patches having increasingly lower energies.

In some examples, the processor passes results of applying optimization operations on the patches of a particular tier of the hierarchy to patches of the next lower tier. For instance, performing the optimization operation on elements of second tier patches may be based on results of applying the optimization operation on elements of third tier patches.

In some examples, a processor uses a hierarchical process based on recursively optimizing groups (e.g., patches) of variables of a system to heuristically find the ground state of spin glasses (e.g., elements being +1 or −1). A relatively simple heuristic process for finding the optimal solution of the system includes generating random spin configurations and recording the energy of the resulting configurations. Such a process is similar to or the same as random guessing. The probability for finding the global ground state of N spins by such a process is 2^{-N} per guess assuming, for sake of simplicity, a non-degenerate ground state. A more sophisticated process for guessing the optimal solution of the system is to generate random configurations of Nᵣ spins so that Nᵣ=N−N_{g} spins and for each configuration find the lowest energy of the remaining N_{g} spins by enumerating all possible combinations of spins. This process may improve the probability of guessing the correct solution, but the cost of finding the optimal orientation of the remaining N_{g} spins may be as much as 2^{Ng}. This process, however, may be extended to solving multiple patches of spins. For example, a processor may choose two patches with N₁ and N₂ spins, respectively, so that spins in one patch do not couple to any of the spins in the other patch. In this case, for each random guess of the remaining Nᵣ=N−N₁−N₂ spins, the complexity of finding the optimal configuration of both of the patches with respect to the rest of the system is 2^{N}₁+2^{N}₂, thus reducing the total complexity by an exponential amount from 2^{N}=2^{(Nr+N}^{₁}^{+N}^{₂}⁾ to 2^{N}=2^{(Nr+N}^{₁}⁾+2^{(Nr+N}^{₂}⁾. In some implementations, the patches rare coupled to one another. In such a case, the complexity of the process for finding the solution for the system decreases from the case where the patches are not coupled to one another.

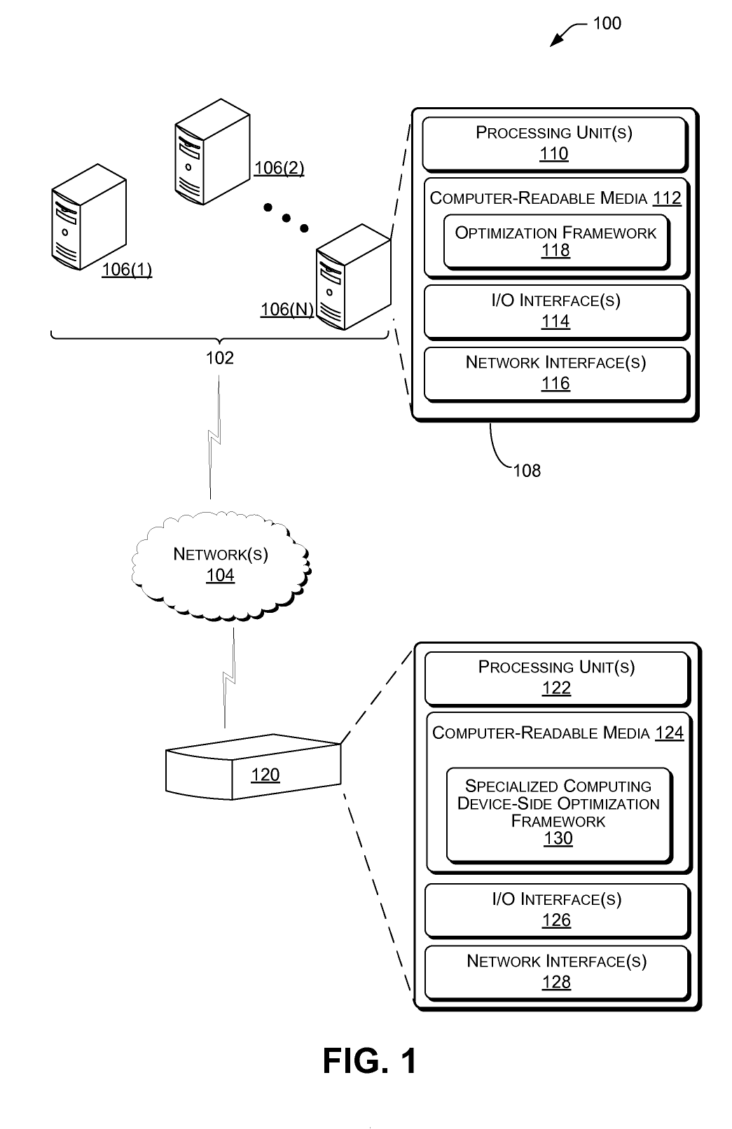

Various examples are described further with reference to FIGS. 1-7.

### Example Environment

FIG. 1 is a block diagram depicting an environment 100 for solving optimization problems using a recursive hierarchical approach, according to various examples. In some examples, the various devices and/or components of environment 100 include distributed computing resources 102 that may communicate with one another and with external devices via one or more networks 104.

For example, network(s) 104 may include public networks such as the Internet, private networks such as an institutional and/or personal intranet, or some combination of private and public networks. Network(s) 104 may also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth) or any combination thereof. Network(s) 104 may utilize communications protocols, including packet-based and/or datagram-based protocols such as internet protocol (IP), transmission control protocol (TCP), user datagram protocol (UDP), or other types of protocols. Moreover, network(s) 104 may also include a number of devices that facilitate network communications and/or form a hardware basis for the networks, such as switches, routers, gateways, access points, firewalls, base stations, repeaters, backbone devices, and the like.

In some examples, network(s) 104 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 1302.11 standards (e.g., 1302.11g, 1302.11n, and so forth), and other standards.

In various examples, distributed computing resource(s) 102 includes computing devices such as devices 106(1)-106(N). Examples support scenarios where device(s) 106 may include one or more computing devices that operate in a cluster or other grouped configuration to share resources, balance load, increase performance, provide fail-over support or redundancy, or for other purposes. Although illustrated as desktop computers, device(s) 106 may include a diverse variety of device types and are not limited to any particular type of device. Device(s) 106 may include specialized computing device(s) 108.

For example, device(s) 106 may include any type of computing device having one or more processing unit(s) 110 operably connected to computer-readable media 112, I/O interfaces(s) 114, and network interface(s) 116. Computer-readable media 112 may have an optimization framework 118 stored thereon. For example, optimization framework 118 may comprise computer-readable code that, when executed by processing unit(s) 110, perform an optimization operation on patches of a set of elements for a system. Also, a specialized computing device(s) 120, which may communicate with device(s) 106 via networks(s) 104, may include any type of computing device having one or more processing unit(s) 122 operably connected to computer-readable media 124, I/O interface(s) 126, and network interface(s) 128. Computer-readable media 124 may have a specialized computing device-side optimization framework 130 stored thereon. For example, similar to or the same as optimization framework 118, optimization framework 130 may comprise computer-readable code that, when executed by processing unit(s) 122, perform an optimization operation.

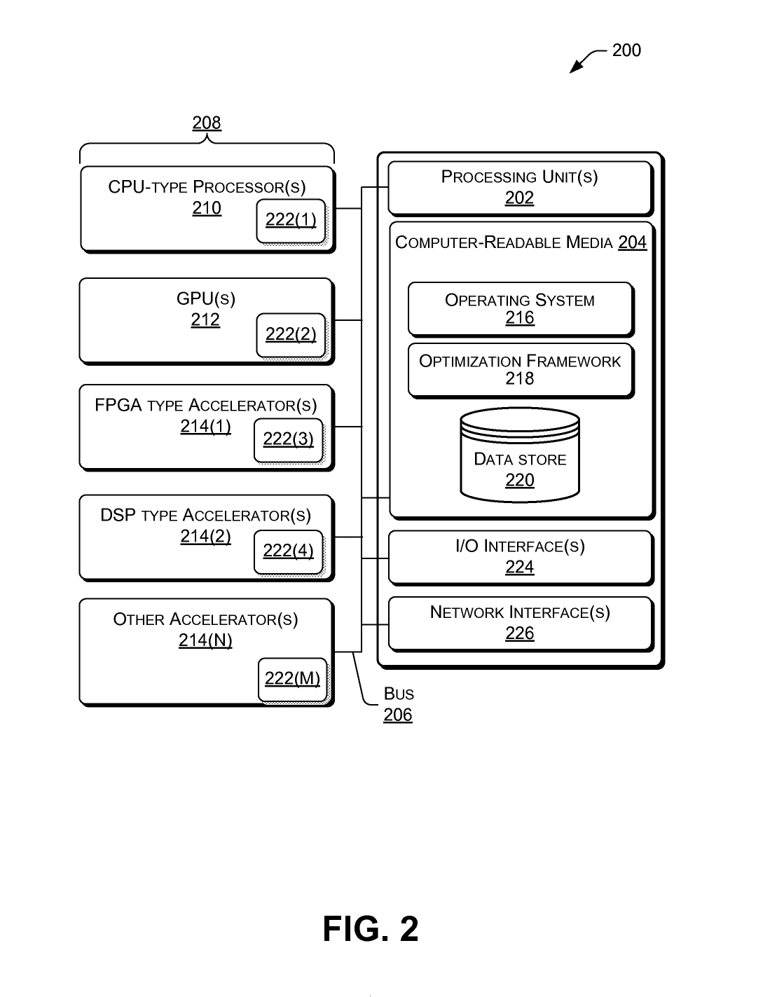

FIG. 2 depicts an illustrative device 200, which may represent device(s) 106 or 108, for example. Illustrative device 200 may include any type of computing device having one or more processing unit(s) 202, such as processing unit(s) 110 or 122, operably connected to computer-readable media 204, such as computer-readable media 112 or 124. The connection may be via a bus 206, which in some instances may include one or more of a system bus, a data bus, an address bus, a PCI bus, a Mini-PCI bus, and any variety of local, peripheral, and/or independent buses, or via another operable connection. Processing unit(s) 202 may represent, for example, a CPU incorporated in device 200. The processing unit(s) 202 may similarly be operably connected to computer-readable media 204.

The computer-readable media 204 may include, at least, two types of computer-readable media, namely computer storage media and communication media. Computer storage media may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. The computer-readable media 112 and the computer-readable media 124 are examples of computer storage media. Computer storage media include, but are not limited to hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

In contrast, communication media may embody computer-readable instructions, data structures, program modules, or other data in a modulated data signal, such as a carrier wave, or other transmission mechanism. As defined herein, computer storage media does not include communication media.

Device 200 may include, but is not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device such as one or more separate processor device(s) 208, such as CPU-type processors (e.g., micro-processors) 210, GPUs 212, or accelerator device(s) 214.

In some examples, as shown regarding device 200, computer-readable media 204 may store instructions executable by the processing unit(s) 202, which may represent a CPU incorporated in device 200. Computer-readable media 204 may also store instructions executable by an external CPU-type processor 210, executable by a GPU 212, and/or executable by an accelerator 214, such as an FPGA type accelerator 214(1), a DSP type accelerator 214(2), or any internal or external accelerator 214(N).

Executable instructions stored on computer-readable media 202 may include, for example, an operating system 216, an optimization framework 218, and other modules, programs, or applications that may be loadable and executable by processing units(s) 202, and/or 210. For example, optimization framework 218 may comprise computer-readable code that, when executed by processing unit(s) 202, perform an optimization operation on patches of a set of elements for a system. Alternatively, or in addition, the functionally described herein may be performed by one or more hardware logic components such as accelerators 214. For example, and without limitation, illustrative types of hardware logic components that may be used include Field-programmable Gate Arrays (FPGAs), Application-specific Integrated Circuits (ASICs), Application-specific Standard Products (ASSPs), quantum devices, such as quantum computers or quantum annealers, System-on-a-chip systems (SOCs), Complex Programmable Logic Devices (CPLDs), etc. For example, accelerator 214(N) may represent a hybrid device, such as one that includes a CPU core embedded in an FPGA fabric.

In the illustrated example, computer-readable media 204 also includes a data store 220. In some examples, data store 220 includes data storage such as a database, data warehouse, or other type of structured or unstructured data storage. In some examples, data store 220 includes a relational database with one or more tables, indices, stored procedures, and so forth to enable data access. Data store 220 may store data for the operations of processes, applications, components, and/or modules stored in computer-readable media 204 and/or executed by processor(s) 202 and/or 210, and/or accelerator(s) 214. For example, data store 220 may store version data, iteration data, clock data, optimization parameters, and other state data stored and accessible by the optimization framework 218. Alternately, some or all of the above-referenced data may be stored on separate memories 222 such as a memory 222(1) on board CPU type processor 210 (e.g., microprocessor(s)), memory 222(2) on board GPU 212, memory 222(3) on board FPGA type accelerator 214(1), memory 222(4) on board DSP type accelerator 214(2), and/or memory 222(M) on board another accelerator 214(N).

Device 200 may further include one or more input/output (I/O) interface(s) 224, such as I/O interface(s) 114 or 126, to allow device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). Device 200 may also include one or more network interface(s) 226, such as network interface(s) 116 or 128, to enable communications between computing device 200 and other networked devices such as other device 120 over network(s) 104. Such network interface(s) 226 may include one or more network interface controllers (NICs) or other types of transceiver devices to send and receive communications over a network.

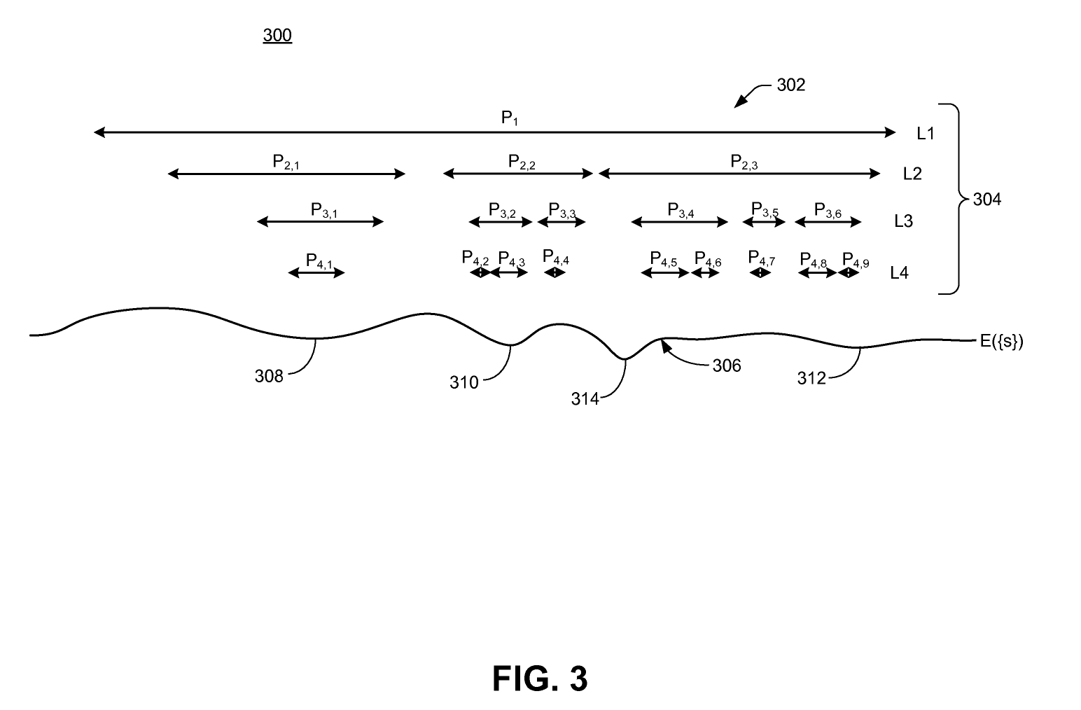

FIG. 3 illustrates a cross-sectional view of a system 300 that includes sets of patches and sub-patches 302 in a number of tiers 304 of a hierarchy in relation to an objective function 306 defined for system 300, according to various examples. For instance, a processor may use sets of patches and sub-patches 302 for a process of minimizing (or maximizing) objective function 306 over a set of states {s} for the system. The processor may use such a process for solving an optimization problem for the system defined by objective function 306.

In some examples, objective function 306 of the system may be a function of a set of elements that are related to one another by equation [1].

E({s})=Σ_{i,j}(J_{i,j}sᵢsⱼ)+Σᵢ(sᵢhᵢ) [1]

J_{i,j} represents a matrix of real numbers indexed over i and j, hᵢ are real numbers, and sᵢ and sⱼ are elements of the set {s}. In some implementations, such elements may comprise a set of real numbers. The first term, which includes J_{i,j}, is a coupling term that defines coupling among the set of elements. In a particular implementation, the set {s} comprises spin states, having values +1 or −1. E({s}) for a system may be called the “energy” of the system. (The terms “spin states” and “energy” arise from an analogy between optimization and metallurgy.) There are N different sᵢ labeled by i=1 . . . N. E({s}) is a function of the set of all s, sᵢ . . . s_{N}. Solving an optimization problem involving E({s}) includes finding the set of elements {s} that yield a maximum or a minimum value for E({s}), though claimed subject matter is not limited in this respect. For the case of the set of elements {s} comprising the set of spins, the optimization problem for E({s}) is carried out over sᵢ=+1 and −1.

Herein, for sake of clarity, discussions of various examples focus on minimization (as opposed to maximization) of the objective function. Generally, an objective function includes a plurality of local minima and one global minimum. For example, the particular E({s}) shown in FIG. 3 includes a number of minima, several of which are shown. In particular, E({s}) includes local minima 308, 310, 312 and a global minimum 314. Solutions to the optimization problem for the system defined by objective function 306 may yield local minima, falling short of finding the global minimum. For at least this reason, techniques for solving optimization problems may be recursive, continuing to seek improvements to the last solution(s) found. For example, a process for solving the optimization problem may yield a first solution that is local minimum 308, and it would not be known whether 308 is a local minimum or the global minimum. Thus, the process may continue to search for a better solution, which is the global minimum 314.

A processor may solve an optimization problem defined by objective function 306 using a recursive hierarchical approach that partitions elements {s} for particular states of the system into patches and sub-patches. For example, a first patch comprises a first subset of the elements {s}, a second patch comprises a second subset of the elements {s}, and so on. Moreover, the processor may partition each of such patches into sub-patches corresponding to tiers. As defined herein, sub-patches of patches are in a higher-order tier as compared to the patches. For example, if a patch is in a second-order tier, then sub-patches of the patch are in a third-order tier. Unless apparent otherwise, depending on the context, the terms “patches” and “sub-patches” are interchangeably used.

A process for solving the optimization problem may be divided into a number of smaller problems, each corresponding to individual patches. In other words, instead of solving the entire optimization problem of a system in a single process, the processor may solve the optimization problem by subdividing the optimization problem recursively into sub-patches, giving rise to a hierarchical solution process. In this fashion, a particular operation that is used to optimize elements of a patch or sub-patch may be applied individually to each of the patches or sub-patches. Details of the particular operation, hereinafter called “SOLVE(p,n)”, may be different for different patches and sub-patches, and depend on which tier the patches or sub-patches reside, as explained below. Here, SOLVE(p,n) is written to indicate that the form of the operation SOLVE(p,n) may depend on which patch or sub-patch p in an nth-order tier SOLVE(p,n) is applied to. In some implementations, the recursive solution process terminates at a relatively small sub-patch size, which the processor solves by an operation different from SOLVE(p,n). For example, SOLVE(p,n) may comprise simulated annealing or some other algorithm for relatively small patches in the highest-order tier, but the processor may implement SOLVE(p,n) recursively by calls to SOLVE on lower-order tiers.

In some particular examples, the hierarchical process of solving the optimization problem for a system includes initializing elements of a patch by randomly setting each of the elements to a random value before applying SOLVE(p,n) to the individual sub-patches of the patch. In this fashion, the processor optimizes the individual sub-patches using a process that includes random local restarts without affecting the global configuration of the elements of the system. The hierarchical process of solving the optimization problem, however, need not involve such random restarts (e.g., random initialization), and claimed subject matter is not limited in this respect.

A process of solving the optimization problem defined by objective function 306 may depend on a parameter L, which is the total number of tiers of the hierarchy that will be considered during the process. As discussed above, each such tier includes one or more patches or sub-patches. Any of a number of methods may be used to define the patches or sub-patches. For example, in one method, for a particular nth-order tier, a patch comprises a set of elements (e.g., spins) within a distance dₙ from some central value (e.g., central spin), where dₙ decreases with increasing n. A choice of dₙ may depend on the particular optimization problem. The distance dₙ may be defined using a graph metric, for example. In other methods, patches or sub-patches may be defined so that the patches or sub-patches include elements that are coupled to one another in some particular way. Such coupling may exist for elements within a distance dₙ from one another. In some implementations, distance dₙ may decrease geometrically with increasing n. For example, such coupling among elements may be defined by J_{i,j} in equation [1].

In the particular example illustrated in FIG. 3, first-order tier L1 includes one patch P₁. In some implementations, a first-order tier may include a single patch comprising an entire set of elements of a system. Second-order tier L2 includes three patches P_{2,1}, P_{2,2}, and P_{2,3}, which are sub-patches of patch P₁. Third-order tier L3 includes six patches P_{3,1}, P_{3,2}, P_{3,3}, P_{3,4}, P_{3,5}, and P_{3,6}, wherein P_{3,1} is a sub-patch of P_{2,1}; P_{3,2} and P_{3,3} are sub-patches of P_{2,2}; and P_{3,4}, P_{3,5}, and P_{3,6} are sub-patches of P_{2,3}.

Fourth-order tier L4 includes nine patches P_{4,1}, P_{4,2}, P_{4,3}, P_{4,4}, P_{4,5}, P_{4,6}, P_{4,7}, P_{4,8}, and P_{4,9}, wherein P_{4,1} is a sub-patch of P_{3,1}; P_{4,2} and P_{4,3} are sub-patches of P_{3,2}; P_{4,4} is a sub-patch of P_{3,3}; P_{4,5} and P_{4,6} are sub-patches of P_{3,4}; P_{4,7} is a sub-patch of P_{3,5}; and P_{4,8} and P_{4,9} are sub-patches of P_{3,6}. Though particular numbers of tiers and sub-patches are illustrated, claimed subject matter is not limited in this respect. Moreover, solving an optimization problem may involve any number of tiers and sub-patches. For example, sub-patch P_{2,1} in second-order tier L2 may include any number of sub-patches in third-order tier L3, and so on. Though not illustrated for sake of clarity, sub-patches may overlap one another. Thus, for example, sub-patch P_{3,2} may overlap with sub-patch P_{3,3}. Herein, overlap means that elements in an overlap (e.g., a union) of patches are shared by the patches (e.g., particular elements are in more than one patch at the same time).

An example of the recursive hierarchical process for solving the optimization problem for system 300 is now described. For sake of clarity, descriptions focus on the hierarchical process that includes higher-order sub-patches of sub-patch P_{2,2}. In other words, for brevity sub-patches of sub-patches P_{2,1} and P_{2,3} are not discussed although the process may be may also be applied to them.

Beginning with the highest-order tier of the hierarchy, a processor may apply an operation SOLVE(4,2) to sub-patch P_{4,2} on fourth-order tier L4 subsequent to randomly initialize the elements of sub-patch P_{4,2}. Such an operation modifies the set of elements of sub-patch P_{4,2}. The modified elements of sub-patch P_{4,2} are a partial solution (e.g., a heuristic solution) to the optimization problem for system 300. In other words, sub-patch P_{4,2} that includes the modified elements may be one of a number of local minima for objective function 306 defined for system 300.

Similarly, the processor may apply an operation SOLVE(4,3) to sub-patch P_{4,3} subsequent to randomly initializing the elements of sub-patch P_{4,3}. Such an operation modifies the set of elements of sub-patch P_{4,3}. The modified elements of sub-patch P_{4,3} are a partial solution (e.g., a heuristic solution) to the optimization problem for system 300. Sub-patch P_{4,3} that includes the modified elements maybe one of a number of local minima for objective function 306 defined for system 300.

Finally for fourth-order tier L4, the processor may apply an operation SOLVE(4,4) to sub-patch P_{4,4} subsequent to randomly initializing the elements of sub-patch P_{4,4}. Such an operation modifies the set of elements of sub-patch P_{4,4}. The modified elements of sub-patch P_{4,4} are a partial solution (e.g., a heuristic solution) to the optimization problem for system 300. Sub-patch P_{4,4} that includes the modified elements may be one of a number of local minima for objective function 306 defined for system 300.

In some implementations, SOLVE(4,2), SOLVE(4,3), and SOLVE(4,4) may be equal to one another and equal to SOLVE(4), which is defined to be an optimization operator used on all sub-patches in fourth-order tier L4.

After finding partial solutions to the optimization problem for system 300 for sub-patches in fourth-order tier L4, the hierarchical process of solving the optimization problem for system 300 proceeds to sub-patches in third-order tier L3. The processor may use the partial solutions resulting from optimization operations (e.g., SOLVE(4)) applied to sub-patches in fourth-order tier L4 to initialize at least some of the elements of sub-patches in third-order tier L3. Other elements may be randomly initialized. The processor passes the values of the elements of the partial solutions at fourth-order tier L4 to third-order tier L3 by returning the values from a subroutine of the optimization operations. In other words, the values of the elements are not passed in the arguments to the subroutine, but instead are returned from the subroutine. Each subroutine at a given tier returns such values to the next-lower tier.

The processor may apply an operation SOLVE(3,2) to sub-patch P_{3,2} subsequent to randomly initializing the elements of sub-patch P_{3,2}. Such an operation modifies the set of elements of sub-patch P_{3,2}. The modified elements of sub-patch P_{3,2} are a partial solution (e.g., a heuristic solution) to the optimization problem for system 300. Sub-patch P_{3,2} that includes the modified elements may be one of a number of local minima for objective function 306 defined for system 300.

Finally for third-order tier L3, the processor may apply an operation SOLVE(3,3) to sub-patch P_{3,3} subsequent to randomly initializing the elements of sub-patch P_{3,3}. Such an operation modifies the set of elements of sub-patch P_{3,3}. The modified elements of sub-patch P_{3,3} are a partial solution (e.g., a heuristic solution) to the optimization problem for system 300. Sub-patch P_{3,3} that includes the modified elements may be one of a number of local minima for objective function 306 defined for system 300.

In some implementations, SOLVE(3,2) and SOLVE(3,3) may be equal to one another and equal to SOLVE(3), which is defined to be an optimization operator used on all sub-patches on third-order tier L3.

After finding partial solutions to the optimization problem for system 300 for sub-patches in third-order tier L3, the hierarchical process of solving the optimization problem for system 300 proceeds to sub-patches in second-order tier L2. The partial solutions resulting from optimization operations (e.g., SOLVE(3)) applied to sub-patches in third-order tier L3 may be used to initialize at least some of the elements of sub-patches in second-order tier L2. Other elements may be randomly initialized. The processor passes the values of the elements of the partial solutions at third-order tier L3 to second-order tier L2 by returning the values from a subroutine of the optimization operations. In other words, the values of the elements are not passed in the arguments to the subroutine, but instead are returned from the subroutine. Each subroutine at a given tier returns such values to the next-lower tier.

The processor may apply an operation SOLVE(2,1) to sub-patch P_{2,1} subsequent to randomly initializing the elements of sub-patch P_{2,1}. Such an operation modifies the set of elements of sub-patch P_{2,1}. The modified elements of sub-patch P_{2,1} are a partial solution (e.g., a heuristic solution) to the optimization problem for system 300. Sub-patch P_{2,1} that includes the modified elements may be one of a number of local minima for objective function 306 defined for system 300.

Similarly, the processor may apply an operation SOLVE(2,2) to sub-patch P_{2,2} subsequent to randomly initializing the elements of sub-patch P_{2,2}. Such an operation modifies the set of elements of sub-patch P_{2,2}. The modified elements of sub-patch P_{4,3} are a partial solution (e.g., a heuristic solution) to the optimization problem for system 300. Sub-patch P_{2,2} that includes the modified elements may be one of a number of local minima for objective function 306 defined for system 300.

Finally for second-order tier L2, the processor may apply an operation SOLVE(2,3) to sub-patch P_{2,3} subsequent to randomly initializing the elements of sub-patch P_{2,3}. Such an operation modifies the set of elements of sub-patch P_{2,3}. The modified elements of sub-patch P_{2,3} are a partial solution (e.g., a heuristic solution) to the optimization problem for system 300. Sub-patch P_{2,3} that includes the modified elements may be one of a number of local minima for objective function 306 defined for system 300.

In some implementations, SOLVE(2,1), SOLVE(2,2), and SOLVE(2,3) may be equal to one another and equal to SOLVE(2), which is defined to be an optimization operator used on all sub-patches in second-order tier L2.

After finding partial solutions to the optimization problem for system 300 for sub-patches in second-order tier L2, the hierarchical process of solving the optimization problem for system 300 proceeds to the set of elements, patch P₁ in first-order tier L1. The partial solutions resulting from optimization operations (e.g., SOLVE(3)) applied to sub-patches in second-order tier L2 may be used to initialize at least some of the elements of the patch in first-order tier L1. Other elements may be randomly initialized. The processor passes the values of the elements of the partial solutions at second-order tier L2 to first-order tier L1 by returning the values from a subroutine of the optimization operations. In other words, the values of the elements are not passed in the arguments to the subroutine, but instead are returned from the subroutine. Each subroutine at a given tier returns such values to the next-lower tier.

Thus, for first-order tier L1, the processor may apply an operation SOLVE(1) to patch P₁ subsequent to randomly initializing the elements of patch P₁. Such an operation modifies the set of elements of patch Pᵢ. The modified elements of patch P₁ are a partial solution (e.g., a heuristic solution) to the optimization problem for system 300. In other words, patch Pᵢ that includes the modified elements is one of a number of local minima for objective function 306 defined for system 300.

In some implementations, SOLVE(1), SOLVE(2), SOLVE(3), and SOLVE(4) may be equal to one another. In other implementations, SOLVE(1), SOLVE(2), and SOLVE(3) may be equal to one another while being unequal to SOLVE(4), which may be an exact solver. In other words, an exact solver may be applied to the highest-order tier. Generally, an exact solver desirably finds an exact solution to an optimization problem, but the exact solver may take a relatively long time to do so. As the tier order increases, sub-patch size decreases. Thus, the highest-order tier includes relatively small sub-patches, to which an exact solver may be applied to yield an exact solution for each sub-patch in a relatively short time. In some examples, the processor may use simulated annealing as a solver for relatively small sub-patches. In some implementations, such a processor may be a quantum device, such as a quantum computer or quantum annealer. For example, a quantum device may be used to perform an optimization operation (e.g., SOLVE(4)) on the highest-order tier that includes relatively small patches.

In some examples, SOLVE(n,p), where n is the tier order and p is a patch or sub-patch, may be described by the following pseudo-code.

If n=L, perform simulated annealing on patch p following a particular

schedule and return. Alternatively, call an exact solver or other solution
routine, or call a classical or quantum solver implemented in hardware,
either digital or analog. Else,

Energy of patch p is computed and stored as E₀.
Current spin configuration of p is stored as S₀.
For m=1 to k, where k is the number of restarts do

Spin configuration in p is randomized.
Perform N calls to Solve(p′, l+1) for N randomly chosen

sub-patches p′. After each call, update the given sub-patch to the
configuration returned by Solve(p′, l+1) if the energy is lower than
the energy of the original. Else, update with temperature dependent
probability.
Energy of final configuration of p is computed and stored as E₁.If E₁
is smaller the E₀, the current spin configuration is retained.
Otherwise, the spin in p is reverted to S₀.
Return the lowest energy configuration for p found.

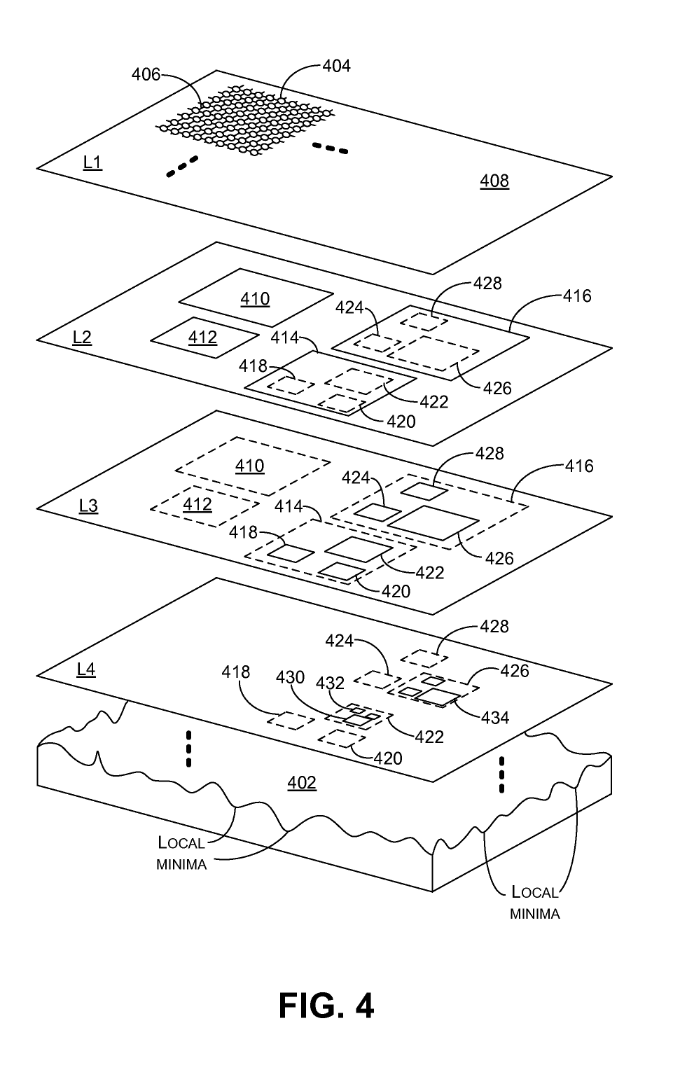

FIG. 4 illustrates a perspective view of a system 400 that includes patches and sub-patches in a number of hierarchical tiers L1-L4 in relation to an objective function 402 defined for the system, according to various examples. For instance, a processor may use patches and sub-patches in the various tiers for a process of minimizing (or maximizing) objective function 402 over a set of states {s} for the system. Such a process may be used for solving an optimization problem for system 400 defined by objective function 402.

In the perspective view in FIG. 4, objective function 402 for a particular set of states {s} is illustrated as a topographical surface having a plurality of extrema, a few of which are labeled. For sake of clarity, a few extrema on the edges of the topology are labeled.

In some examples, objective function 402 of system 400 may be a function of a set of elements {s} that are related to one another by an equation such as equation [1], described above. A number of elements 404 in first-order tier L1 are illustrated as small circles interconnected by lines 406, which represent the possibility that any of the elements may be coupled to one or more other elements, though such coupling need not exist for all the elements. In some implementations, such elements may comprise a set of real numbers. In a particular implementation, the set {s} comprises spin states, having values +1 or −1.

Similar to examples described in relation to FIG. 3, a processor may solve an optimization problem defined by objective function 402 using a hierarchical approach that partitions elements {s} for particular states of the system into patches and sub-patches. For example, a first patch comprises a first subset of the elements {s}, a second patch comprises a second subset of the elements {s}, and so on. Moreover, the processor may further partition each of such patches into sub-patches corresponding to hierarchical tiers. As defined herein, sub-patches of patches are in a higher-order tier as compared to the patches. For example, if a patch is in a second-order tier, then sub-patches of the patch are in a third-order tier.

In the particular example illustrated in FIG. 4, first-order tier L1 includes one patch 408, which includes all of the elements in L1. Patch 408 may be partitioned into patches 410, 412, 414, and 416. Thus, second-order tier L2 includes four patches 410, 412, 414, and 416, which are sub-patches of patch 408. As explained above, the processor may partition individual patches into sub-patches, which in turn may be partitioned into higher-order patches, and so on. Thus, continuing with the description of FIG. 4, the processor may partition each of patches 410, 412, 414, and 416 into sub-patches so that, for example, patch 414 includes sub-patches 418, 420, and 422. Patch 416 includes sub-patches 424, 426, and 428. Patches 410, 412, 414, and 416 are illustrated with dashed outlines on third-order tier L3 and solid outlines in second-order tier L2.

For the next higher-order tier, which is fourth-order tier L4, the processor may partition each of patches 418, 420, 422, 424, 426, and 428 (which are sub-patches of patches 414 and 416, respectively) into sub-patches so that, for example, patch 422 includes sub-patches 430 and 432. Patch 426 includes sub-patches 434. For sake of clarity, not all sub-patches are labeled. Patches 418, 420, 422, 424, 426, and 428 are illustrated with dashed outlines in fourth-order tier L4 and solid outlines in third-order tier L3.

The hierarchical process of iteratively defining sub-patches on increasing-order tiers may continue beyond fourth-order tier L4. Though particular numbers of tiers and sub-patches are illustrated, claimed subject matter is not so limited. Moreover, solving an optimization problem may involve any number of tiers, patches, and sub-patches. For example, patch 414 in second-order tier L2 may include any number of sub-patches in third-order tier L3, and so on. Though not illustrated for sake of clarity, patches or sub-patches may overlap one another. Thus, for example, patch 414 may overlap with patch 416.

A processor may perform a hierarchical process for solving the optimization problem for system 400 the same as or similar to the process for system 300. In a particular example implementation, the hierarchical process may involve a process of simulated annealing for solving optimization problems for any of the patches or sub-patches in tiers L1-L4. For example, a processor may use simulated annealing on sub-patches of the highest-order tier. In other words, the processor may apply an operation SOLVE(n) comprising a simulated annealing operation, wherein n is the order number of the highest ordered tier, to sub-patches in the nth-order tier. In some implementations, however, the processor may apply simulated annealing to patches or sub-patches in any tier. For an illustrative case, elements sᵢ in the set {s} of system 400 may comprise spins having values of +1 or −1. In this case, in the process of simulated annealing the processor initializes the elements sᵢ of a sub-patch randomly to +1 or −1, choosing each one independently in a process of random initialization. An example of finding a solution for a system of spins in described below.

In some implementations, a parameter called the “temperature” T is chosen based on any of a number of details regarding system 400. A processor may choose different values for T for different sub-patches and/or for different iterations of the hierarchical process. Subsequent to random initialization, the processor performs a sequence of “annealing steps” using the chosen value for T. In an annealing step, the processor modifies elements sᵢ to generate a new set {s′} for the sub-patch, where values of sᵢ may be flipped from +1 to −1 or vice-versa. The processor then determines whether the energy of new set {s′} is lower than the energy of the original set {s}. In other words, the processor determines whether the annealing step yielded a new energy E(s′) lower than the original energy E(s). If so, if E(s′)<E(s), the processor replaces (e.g., “accepts the update”) elements of the set {s} with elements of the set {s′}. On the other hand, if E(s′)>E(s), the processor conditionally replaces elements of the set {s} with elements of the set {s′} based on a probability that may depend on a difference between E(s′), E(s), and T. For example, such a probability may be expressed as exp[−(E(s′)−E(s))/T], where “exp” is the exponential operator that acts on the expression within the square brackets. The processor performs a sequence of annealing steps at a given T, then reduces T, again performs annealing, and continues in this iterative fashion. The sequence of T and the number of annealing steps for each T is termed the “schedule”. At the end of the process, T may be reduced to zero, and the last configuration of elements of a new set {s″} is a candidate for the minimum. The processor performs several restarts of the process, starting again with a randomly initialized configuration and again reducing T following a schedule and the best choice of {s} at the end of the process may be the best candidate for the minimum. An example implementation of the overall process is summarized by the following pseudo-code;

For m=1 to k, where k is the number of restarts, do

Initialize {s} at random
For c =1 to l, where l is the number of different choices of

temperature (determined from the schedule) do

Set T to the value T_{c} determined from the schedule.
Perform N_{c} annealing steps, where N_{c} is determined from
the schedule
Return the lowest energy configuration found in the

annealing algorithm

The choice of the schedule for T may be specified by a particular sequence of T and a particular sequence of the number of steps performed at each temperature. The schedule may also specify the number of restarts. A simulated annealing process may be performed in parallel at different values for T, for example.

In an example system described by a set of spins, the processor may find the global ground state for the system by a process of recursively optimizing sub-sets of spins. The processor may start with a random global state and sequentially pick M subsets having N_{g} spins in each subset. The processor may optimize configurations of the subsets by applying an operator SOLVE.

A new spin configuration G obtained by optimizing a patch of spins may either replace the previous configuration, or in case of heuristic solvers, replace the previous configuration if the configuration energy is lowered. Alternatively, such replacement may be based on a probabilistic criterion. For a patch size where N_{g}=1, the process may be the same as or similar to simulated annealing.

For larger spin patches, the processor may solve each such patch by subdividing the patch recursively into sub-patches, giving rise to a hierarchical process. In other words, the processor may apply a function SOLVE to subsets of the spins in each patch. Recursion of such a hierarchical process may terminate at a relatively small patch size, which may be solved by another process, for example.

As described above, the processor randomly initializes the configuration of each patch before solving it by optimizing patches of the patches, thus implementing random local restarts without affecting the global spin configuration. This randomization also implies that it makes no sense to solve a particular patch more than once in a row, but rather a new patch may be chosen after one patch has been optimized. A random restart, however, is merely one possible way to initialize the state of a patch, and claimed subject matter is not limited in this respect.

In some examples, patches are defined so that spins within a patch are strongly coupled to one another and weakly coupled to the system outside of the patch. Such a patch may be built by starting from a single spin and adding spins until the patch has reached a desired size. Spins that are most strongly coupled to the patch and weakly to the rest of the system may be added first. Thus, spins neighboring those already in the patch may be considered. In other examples, single spins may be added probabilistically. In still other examples, instead of single spins, sets of spins may be added to a patch.

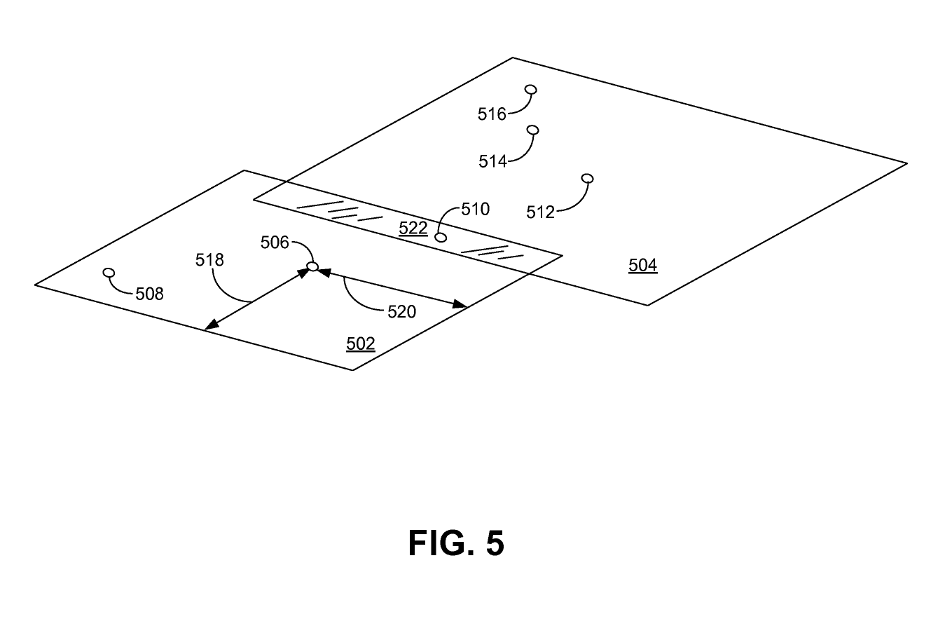

FIG. 5 illustrates two patches 502 and 504, according to some examples. A processor may use such patches in an optimization problem defined by an objective function E({s}) for a system that associates elements sᵢ of a set {s}. Patches 502 and 502 may be in a particular nth-order tier. Patches 502 and 504 result from partitioning elements {s} for particular states of the system. For example, patch 502 comprises a first subset of the elements {s}, a few of which are shown. In particular, patch 502 includes elements 506, 508, and 510. For the discussion below, element 506 is considered to be a “patch-center” element. Patch 504 comprises a second subset of the elements {s}, a few of which are shown. In particular, patch 504 includes elements 510, 512, 514, and 516. Though not illustrated in FIG. 5, additional patches may exist and such patches may be partitioned into sub-patches that comprise subsets of the set {s}.

Though illustrated as being square-shaped and two-dimensional, patches 502 and 504 may have any shape and have any number of dimensions. Patches may be defined in any of a number of ways. For example, patch 502 may be defined to include a subset of elements that are within a distance 518 of patch-center element 506 in a first direction and are within a distance 520 of central element 506 in a second direction. In other examples, not shown, a circular or spherical patch may be defined to include a subset of elements that are within a radial distance of a central element. A choice of such distances may depend on the particular optimization problem. Distance may be defined using a graph metric, for example.

Patches may overlap one another. For example, patch 502 and patch 504 overlap so that both include a subset of elements in a region 522. One such element is 510, which is an element of both patch 502 and patch 504.

Elements of the set {s} may be coupled to one another in various ways. In some implementations, a matrix of real numbers, such as J_{i,j} in equation [1], may define the coupling among the elements. For example, coupling among the elements may be based on distances between respective elements. In some implementations, such distances may decrease geometrically with increasing tier order. The strength of such coupling may also vary among pairs of elements within a particular tier. For example, coupling between elements 514 and 516 may be weaker than coupling between elements 514 and 510. A patch may be defined so that the patch includes elements that are more strongly coupled to each other, relative to elements outside the patch.

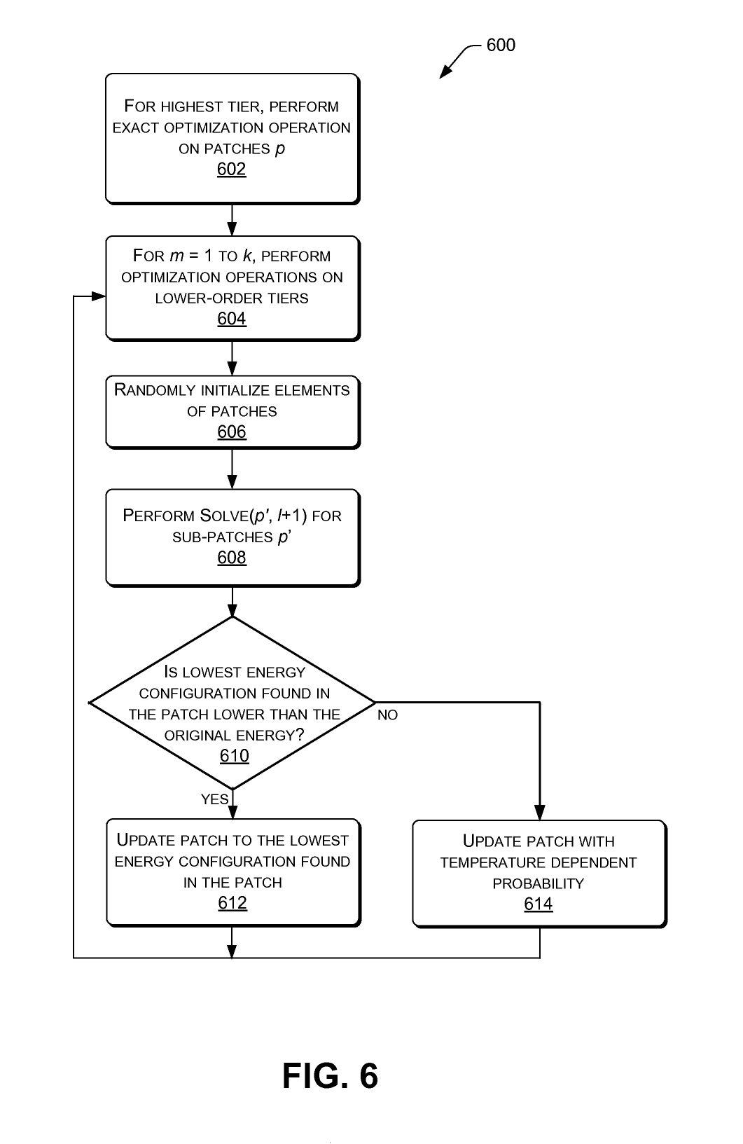

FIG. 6 is a flow diagram illustrating a process 600 for solving an optimization problem, according to some examples. Process 600, which may be performed by a processor such as processing unit(s) 110, 122, and 202, for example, involves defining a number of patches hierarchically in a number of tiers. In particular, a processor partitions patches in a first-order tier into sub-patches in a next higher-order tier, and the sub-patches are themselves partitioned in sub-patches in still a next higher-order tier, and so on. Accordingly, sub-patches in higher tiers are smaller than corresponding patches (or sub-patches) in lower tiers. For at least this reason, optimization operations performed on sub-patches in higher-order tiers tend to more easily find solutions as compared to patches (or sub-patches) in lower tiers. In some implementations, the processor applies an “exact” solver for an optimization operation to patches of a highest-order tier. Here, the term “exact” indicates that the solver is configured to find global extrema, though claimed subject matter is not limited in this respect. Thus, at block 602, the processor applies an exact solver to patches p in the highest-order tier. For example, such a solver may incorporate simulated annealing.

At block 604, according to a schedule that specifies the number of restarts k for individual patches, the processor performs optimization operations on the individual patches. For each such operation, elements of the patches are randomly initialized at block 606. In some implementations, however, the elements may be initialized in a non-random fashion. At block 608, the processor performs an operation SOLVE for the sub-patches. Particular details regarding SOLVE may depend on which sub-patch p′ and which tier l SOLVE operates. Performing the operation SOLVE on a sub-patch generates a modified sub-patch. At block 610, the processor compares the resulting energy of the modified sub-patch to the energy of the patch before the SOLVE operation. If the SOLVE operation yielded a lower energy, then process 600 proceeds to block 612 where elements of the modified sub-patch are retained and used for a subsequent application of the SOLVE operation. On the other hand, if the SOLVE operation yielded an energy higher than the previous energy, then process 600 proceeds to block 614 where the elements of the modified sub-patch are either discarded or are retained based on a probability function and used for a subsequent application of the optimization operation. Such a probability function may depend on a number of parameters, such as the tier of the sub-patch, number of SOLVE operations performed, temperature, and so on.

After performing the SOLVE operation, process 600 returns to block 604 where portions of process 600 are repeated in a restart process. For example, the individual elements of the sub-patches may be randomly re-initialized and the restart process repeats the SOLVE operations on the sub-patches having the re-initialized elements. Subsequent restart processes tend to yield sub-patches having increasingly lower energies.

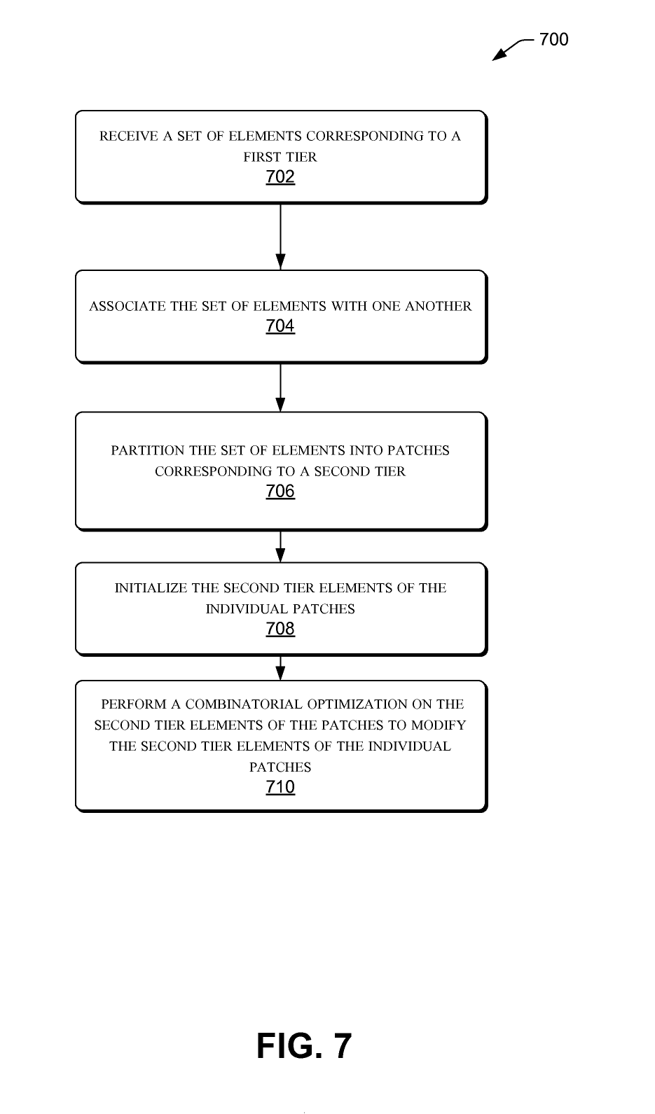

FIG. 7 is a flow diagram illustrating a process 700 for hierarchically solving an optimization problem, according to some examples. For instance, processing unit(s) 110, illustrated in FIG. 1, may perform process 700. Accordingly, at block 702, a processing unit receives a set of elements {s}, which may be sampled or collected data. The set of elements is defined to be in a first tier. At block 704, the processing unit uses an objective function to associate each of the elements to one another. For example, such an objective function may be the same as or similar to equation [1], and may include a term or factor that expresses how the elements are coupled to one another. At block 706, the processing unit partitions the set of elements into patches, which correspond to a second tier. The individual patches include second tier elements that are subsets of the set of elements. The individual patches also have an energy representative of the configuration of the elements in the individual sub-patches.

At block 708, the processing unit randomly initializes the second tier elements of each of the patches. Based on the objective function, at block 710, the processing unit performs a combinatorial optimization operation on the second tier elements of the patches. This operation modifies the second tier elements of the patches, and thus modifies the energy configuration of the patches. In some implementations, process 700 yields a solution that minimizes the energy configurations for the individual patches. A global minimum for the set of elements and the objective function can ultimately be found.

### Example Clauses

A: A method comprising: receiving a set of elements corresponding to a first tier; receiving an objective function that associates the set of elements with one another; partitioning the set of elements into patches corresponding to a second tier, wherein the patches individually include second tier elements that are subsets of the set of elements, and wherein each of the patches has an energy configuration; randomly initializing the second tier elements of the patches; and based, at least in part, on the objective function, performing a combinatorial optimization operation on the second tier elements of the individual patches to modify the second tier elements of the individual patches.

B: A method as paragraph A recites, wherein the combinatorial optimization operation comprises simulated annealing.

C: A method as paragraph A or B recites, further comprising: after performing the combinatorial optimization operation, performing restarts for the patches by randomly re-initializing the second tier elements of the patches.

D: A method as any one of paragraphs A-C recites, further comprising: partitioning the patches individually into sub-patches corresponding to a third tier, wherein the sub-patches individually include third tier elements that are subsets of the second tier elements, and wherein each of the sub-patches has an energy configuration; randomly initializing the third tier elements of the sub-patches; and based, at least in part, on the objective function, performing the combinatorial optimization operation on the third tier elements of the individual sub-patches to modify the third tier elements of the sub-patches.

E: A method as paragraph D recites, wherein performing the combinatorial optimization operation on the second tier elements of the patches is based, at least in part, on the modified third tier elements of the sub-patches.

F: A method as paragraph D recites, wherein the objective function includes a coupling term that defines coupling among the set of elements.

G: A method as any one of paragraphs A-F recites, further comprising: comparing energy configurations of individual of the patches having the second tier elements to energy configurations of individual of the patches having the modified second tier elements; and based, at least in part, on the comparing, determining whether to update the patches by replacing the second tier elements in individual of the patches with the modified second tier elements.

H: A method as any one of paragraphs A-F recites, further comprising: comparing energy configurations of individual of the patches having the second tier elements to energy configurations of individual of the patches having the modified second tier elements; and based, at least in part, on a probability function (relation), updating the patches by replacing the second tier elements in the patches with the modified second tier elements.

I: A method as paragraph H recites, wherein sizes of individual of the patches are unchanged during the updating.

J: A method as any one of paragraphs A-I recites, wherein partitioning the set of elements into the patches corresponding to the second tier comprises, for an individual patch of the two or more patches: selecting a patch-center element among the set of elements; and selecting elements among the set of elements that surround the patch-center element, wherein the selected elements comprise the second-tier elements, and wherein the second-tier elements are within a particular coupling distance from the patch-center element.

K: A method as paragraph J recites, wherein the second-tier elements are coupled to one another based, at least in part, on respective distances between the second-tier elements and the patch-center element.

L: A method as any one of paragraphs A-K recites, wherein at least a portion of the second-tier elements of one of the patches are coupled to at least a portion of the second-tier elements of another one of the patches.

M: A system comprising: one or more processing units; and computer-readable media with modules thereon, the modules comprising: a memory module to store a set of elements and an objective function that associates the set of elements with one another; a partitioning module to partition the set of elements into second-tier patches, third-tier patches, and fourth-tier patches, wherein: the fourth-tier patches are within the third-tier patches and the third-tier patches are within the second-tier patches, and individual of the second-tier patches comprises first subsets of the set of elements, individual of the third-tier patches comprises second subsets of the first subsets, and individual of the fourth-tier patches comprises third subsets of the second subsets; an initializing module to initialize the second-tier patches, the third-tier patches, and the fourth-tier patches; and a solving module to perform, based at least in part on the objective function, a combinatorial optimization operation on: the second-tier patches to modify the elements of the first subsets, the third-tier patches to modify the elements of the second subsets, and the fourth-tier patches to modify the elements of the third subsets.

N: A system as paragraph M recites, wherein the combinatorial optimization operation comprises simulated annealing.

O: A system as paragraph M or N recites, wherein the solving module performs the combinatorial optimization operation a greater number of times for the third tier patches than for the second tier patches.

P: A system as any one of paragraphs M-O recites, wherein the partitioning module is configured to: randomly select sizes of the second-tier patches, the third-tier patches, and the fourth-tier patches.

Q: A system any one of paragraphs M-P recites, wherein the partitioning module is configured to: select sizes of the second-tier patches, the third-tier patches, and the fourth-tier patches based, at least in part, on coupling among the set of elements.

R: One or more computer-readable media storing computer-executable instructions that, when executed on one or more processors, configure a computer to perform acts comprising: partitioning a set of elements into second-tier patches, third-tier patches, and fourth-tier patches, wherein the fourth-tier patches are within the third-tier patches and the third-tier patches are within the second-tier patches, and wherein individual of the second-tier patches comprises first subsets of the set of elements, individual of the third-tier patches comprises second subsets of the first subsets, and individual of the fourth-tier patches comprises third subsets of the second subsets; initializing the second-tier patches, the third-tier patches, and the fourth-tier patches; and based at least in part on an objective function that associates the set of elements with one another, performing a combinatorial optimization operation on (i) the second-tier patches to modify the elements of the first subsets, (ii) the third-tier patches to modify the elements of the second subsets, and (iii) the fourth-tier patches to modify the elements of the third subsets.

S: One or more computer-readable media as paragraph R recites, wherein the acts further comprise: randomly selecting sizes of the second-tier patches, the third-tier patches, and the fourth-tier patches.

T: One or more computer-readable media as paragraph R or S recites, wherein the acts further comprise: selecting sizes of the second-tier patches, the third-tier patches, and the fourth-tier patches based, at least in part, on coupling among the set of elements.

### CONCLUSION

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

All of the methods and processes described above may be embodied in, and fully automated via, software code modules executed by one or more general purpose computers or processors. The code modules may be stored in any type of computer-readable medium, computer storage medium, or other computer storage device. Some or all of the methods may alternatively be embodied in specialized computer hardware such as, for example, a quantum computer or quantum annealer.

Conditional language such as, among others, “can,” “could,” “may” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving a set of elements corresponding to a first tier;
receiving an objective function that associates the set of elements with one another;
partitioning the set of elements into patches corresponding to a second tier, wherein the patches individually include second tier elements that are subsets of the set of elements, and wherein individual of the patches has an energy configuration;
randomly initializing the second tier elements of the patches; and
based, at least in part, on the objective function, performing a combinatorial optimization operation on the second tier elements of the individual patches to modify the second tier elements of the individual patches.

2. The method of claim 1, wherein the combinatorial optimization operation comprises simulated annealing.

3. The method of claim 1, further comprising:
after performing the combinatorial optimization operation, performing restarts for the patches by randomly re-initializing the second tier elements of the patches.

4. The method of claim 1, further comprising:
partitioning the patches individually into sub-patches corresponding to a third tier, wherein the sub-patches individually include third tier elements that are subsets of the second tier elements, and wherein individual of the sub-patches has an energy configuration;
randomly initializing the third tier elements of the sub-patches; and
based, at least in part, on the objective function, performing the combinatorial optimization operation on the third tier elements of the individual sub-patches to modify the third tier elements of the sub-patches.

5. The method of claim 4, wherein performing the combinatorial optimization operation on the second tier elements of the patches is based, at least in part, on the modified third tier elements of the sub-patches.

6. The method of claim 4, wherein the objective function includes a coupling term that defines coupling among the set of elements.

7. The method of claim 1, further comprising:
comparing energy configurations of individual of the patches having the second tier elements to energy configurations of individual of the patches having the modified second tier elements; and
based, at least in part, on the comparing, determining whether to update the patches by replacing the second tier elements in individual of the patches with the modified second tier elements.

8. The method of claim 1, further comprising:
comparing energy configurations of individual of the patches having the second tier elements to energy configurations of individual of the patches having the modified second tier elements; and
based, at least in part, on a probability function (relation), updating the patches by replacing the second tier elements in the patches with the modified second tier elements.

9. The method of claim 8, wherein sizes of individual of the patches are unchanged during the updating.

10. The method of claim 1, wherein partitioning the set of elements into the patches corresponding to the second tier comprises, for an individual patch of the two or more patches:
selecting a patch-center element among the set of elements; and
selecting elements among the set of elements that surround the patch-center element, wherein the selected elements comprise the second-tier elements, and wherein the second-tier elements are within a particular coupling distance from the patch-center element.

11. The method of claim 10, wherein the second-tier elements are coupled to one another based, at least in part, on respective distances between the second-tier elements and the patch-center element.

12. The method of claim 1, wherein at least a portion of the second-tier elements of one of the patches are coupled to at least a portion of the second-tier elements of another one of the patches.

13. A system comprising:
one or more processing units; and
computer-readable media with modules thereon, the modules comprising:
a memory module to store a set of elements and an objective function that associates the set of elements with one another;
a partitioning module to partition the set of elements into second-tier patches, third-tier patches, and fourth-tier patches, wherein:
the fourth-tier patches are within the third-tier patches and the third-tier patches are within the second-tier patches, and
individual of the second-tier patches comprises first subsets of the set of elements, individual of the third-tier patches comprises second subsets of the first subsets, and individual of the fourth-tier patches comprises third subsets of the second subsets;
an initializing module to initialize the second-tier patches, the third-tier patches, and the fourth-tier patches; and
a solving module to perform, based at least in part on the objective function, a combinatorial optimization operation on:
the second-tier patches to modify the elements of the first subsets,
the third-tier patches to modify the elements of the second subsets, and
the fourth-tier patches to modify the elements of the third subsets.

14. The system of claim 13, wherein the combinatorial optimization operation comprises simulated annealing.

15. The system of claim 13, wherein the solving module performs the combinatorial optimization operation a greater number of times for the third tier patches than for the second tier patches.

16. The system of claim 13, wherein the partitioning module is configured to:
randomly select sizes of the second-tier patches, the third-tier patches, and the fourth-tier patches.

17. The system of claim 13, wherein the partitioning module is configured to:
select sizes of the second-tier patches, the third-tier patches, and the fourth-tier patches based, at least in part, on coupling among the set of elements.

18. One or more computer-readable media storing computer-executable instructions that, when executed on one or more processors, configure a computer to perform acts comprising:
partitioning a set of elements into second-tier patches and third-tier patches,
wherein the third-tier patches are within the second-tier patches, and
wherein individual of the second-tier patches comprises first subsets of the set of elements and individual of the third-tier patches comprises second subsets of the first subsets;
initializing the second-tier patches and the third-tier patches; and
based at least in part on an objective function that associates the set of elements with one another, performing a combinatorial optimization operation on (i) the second-tier patches to modify the elements of the first subsets, and (ii) the third-tier patches to modify the elements of the second subsets.

19. The computer-readable media of claim 18, wherein the acts further comprise:
randomly selecting sizes of the second-tier patches and the third-tier patches.

20. The computer-readable media of claim 18, wherein the acts further comprise:
selecting sizes of the second-tier patches and the third-tier patches based, at least in part, on coupling among the set of elements.
